(19) United States
(12) Patent Application Publication
(10) Pub. No.: US 2024/0241258 A1
(43) Pub. Date: Jul. 18, 2024

(54) METHOD AND SYSTEM FOR VERIFYING TRACKING INFORMATION

(71) Applicants: HYUNDAI MOTOR COMPANY, Seoul (KR); KIA CORPORATION, Seoul (KR)

(72) Inventor: Hyun Ju Kim, Yongin-si (KR)

(73) Assignees: HYUNDAI MOTOR COMPANY, Seoul (KR); KIA CORPORATION, Seoul (KR)

(21) Appl. No.: 18/519,950

(22) Filed: Nov. 27, 2023

(30) Foreign Application Priority Data
Jan. 13, 2023 (KR) 10-2023-0005338

(51) Int. Cl. G01S 17/89; G01S 17/931

(52) U.S. Cl. CPC G01S 17/89; G01S 17/931

(57) ABSTRACT

A method for verifying tracking information may include updating verification information of each of the tracking channels based on output information corresponding to object tracking information of each of the tracking channels, generating reliability of the verification information of each of the tracking channels, generating a verification protocol for verifying an output of at least one tracking function of the first tracking channel among the tracking channels based on the reliability of the verification information, and performing output verification of at least one tracking function of the first tracking channel.

### CROSS-REFERENCE TO RELATED APPLICATION

The present application claims priority to Korean Patent Application No. 10-2023-0005338, filed on Jan. 13, 2023, the entire contents of which is incorporated herein for all purposes by this reference.

### BACKGROUND OF THE PRESENT DISCLOSURE

### Field of the Present Disclosure

The present disclosure may provide a method and system for verifying information output for tracking a target object.

### Description of Related Art

A track for tracking the target object may be generated based on points obtained from the LiDAR.

Due to the characteristic of the LiDAR itself, when the target object is covered by another object, the shape of the track of the target object being tracked by the system of the vehicle may be changed or a plurality of tracks may be generated.

The track for tracking the target object may be managed for each identification (ID), and may be used as object recognition information of the vehicle system. Accordingly, maintaining the ID of the track of one target object and managing the track so as not to be separated may greatly affect the object recognition performance of the vehicle system.

For example, the system of the vehicle may control driving of the vehicle by use of shape information of a track having an ID as a main information. Accordingly, when the ID of the track is not maintained or is divided into several IDs by separation, it may cause deterioration in driving performance of the vehicle.

Accordingly, verification of information output for tracking the target object including the track generated based on the points of the LiDAR is a procedure required for stability of the driving control of the vehicle.

However, a technology for verifying information output for tracking the target object has not been developed until now.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and a system for verifying tracking information configured for verifying output information of a system for tracking a target object of a vehicle.

For example, the method and system for verifying tracking information may provide a related technology (or a processor) to verify and respond to an error of output information according to the tracking of an object of the LiDAR-based recognition technology.

Furthermore, the method and the system for verifying tracking information may verify an error of each output information and provide the related technology to respond to the error in consideration of a limitation of a physical change amount of each output information, according to the tracking of the object of the LIDAR-based recognition technology.

Furthermore, the method and the system for verifying tracking information provide a structure configured for reusing information of a time point with high reliability of the past, and provide a related technology configured for responding by verifying the error of output information, according to the tracking of the object.

According to an exemplary embodiment of the present disclosure, the method for verifying tracking information may include updating verification information of each of tracking channels based on output information corresponding to object tracking information of each of the tracking channels; generating reliability of the verification information of each of the tracking channels; and performing output verification of at least one tracking function of a first tracking channel among the tracking channels by using a verification protocol for the output verification of the at least one tracking function of the first tracking channel based on the reliability of the verification information.

The method for verifying tracking information may further include determining the first tracking channel as an abnormal tracking channel based on the output verification of the at least one tracking function and performing post-processing on the abnormal tracking channel.

The post-processing may include at least one of adjusting reliability of the abnormal tracking channel, switching to a memory track to maintain a track of the abnormal tracking channel without outputting the track of the abnormal tracking channel, or deleting the abnormal tracking channel.

The updating the verification information of each of the tracking channels may include performing at least one of updating tracking verification information for each of the tracking channels or generating classification information for template matching verification based on whether a target object of each of the tracking channels is a stationary object or a moving object.

The updating of the tracking verification information may include updating tracking trace information including a position, a velocity, a heading, a width, a length, a classification information, and a tracking reliability or a status information of the target object of a corresponding tracking channel based on the output information of the corresponding tracking channel; updating tracking verification information including a heading, an average width, an average length, an average velocity, or a maximum movement distance of the target object of the corresponding tracking channel based on the updated tracking trace information; determining an accumulated reliability score of the classification information of the target object of the corresponding tracking channel based on the updated tracking verification information to update the classification information for verification; and updating a tracking box for verification based on the updated tracking verification information.

The generating of the classification information for the template matching verification may include generating a point grid map based on LiDAR points of the target object of the corresponding tracking channel; and determining and outputting classification information of the target object of the corresponding tracking channel based on a matching result between pre-stored template information and the point grid map.

The generating of the reliability of the verification information may include generating a reliability of the tracking trace information for verification of each of the tracking channels based on whether the tracking trace information of each of the tracking channels exists in a driving road of a host vehicle; generating a reliability of the classification information for verification of each of the tracking channels based on the accumulated reliability of classification information of the target object of each of the tracking channels and the reliability of matching-based classification information of the point grid map of each of the tracking channels and the pre-stored template information for each moving object; and determining the reliability of the verification information based on at least one of a number of updates of the tracking trace information of each of the tracking channels, the reliability of the tracking trace information for verification, or the reliability of the classification information for verification.

The verification protocol may include at least one of a first verification of appropriateness of a memory track of the first tracking channel for maintaining a track of the first tracking channel without outputting the track of the first tracking channel; a second verification of appropriateness of an output including at least one of appropriateness of a determination that a target object of the first tracking channel is a moving object or a stationary object or appropriateness of output information of the first tracking channel; or a third verification of tracking issue performance of the first tracking channel.

The third verification of the tracking issue performance of the first tracking channel may include at least one of a verification as to whether the track of the target object of the first tracking channel is a track of an object including exhaust gas; verification as to whether the track of the target object of the first tracking channel is an occlusion track; verification as to whether the track of the target object of the first tracking channel is a track representing a pedestrian; verification as to whether the track of the target object of the first tracking channel is a track representing a one-ton truck, or a verification as to whether the track of the target object of the first tracking channel is a track of a sensor boundary region.

The output verification of the at least one tracking function of the first tracking channel may be performed when the reliability of the verification information is a highest level among predetermined levels, and the method may further include when the reliability of the verification information is lower than the highest level, checking object tracking information of a corresponding tracking channel among the tracking channels based on verification information of the corresponding tracking channel.

According to an exemplary embodiment of the present disclosure, a system for verifying tracking information may include a memory configured to store verification information of each of tracking channels; and a processor electrically connected or communicatively connected to the memory, wherein the processor is configured to: update the verification information of each of the tracking channels stored in the memory based on output information corresponding to object tracking information of each of the tracking channels; generate reliability of the verification information of each of the tracking channels; and perform output verification of at least one tracking function of a first tracking channel among the tracking channels by using a verification protocol for the output verification of the at least one tracking function of the first tracking channel based on the reliability of the verification information.

The processor may further include determining the first tracking channel as an abnormal tracking channel based on the output verification of the at least one tracking function and post-processing the identified abnormal tracking channel.

The processor may further perform post-processing on an abnormal tracking channel identified based on the output verification of the at least one tracking function of the tracking channels.

The processor may further include at least one of: adjusting reliability of the abnormal tracking channel; switching to a memory track of the abnormal tracking channel for maintaining the track without outputting the track of the abnormal tracking channel; or deleting the abnormal tracking channel.

The processor may further include update verification information of each of the tracking channels by performing at least one of updating tracking verification information for each of the tracking channels or generating classification information for template matching verification based on whether a target object of each of the tracking channels is a stationary object or a moving object.

The processor may further include updating tracking trace information including a position, a velocity, a heading, a width, a length, classification information, and tracking reliability or status information of a target object of a corresponding tracking channel based on output information of the corresponding tracking channel; updating tracking verification information including a heading, an average width, an average length, an average velocity, or a maximum movement distance of the target object of the corresponding tracking channel based on the updated tracking trace information; determining an accumulated reliability score of the classification information of the target object of the corresponding tracking channel based on the updated tracking verification information to update the classification information for verification; and updating a tracking box for verification based on the updated tracking verification information.

The processor is configured to generate a point grid map based on LiDAR points of the target object of the corresponding tracking channel, determine classification information of the target object of the corresponding tracking channel based on a matching result between pre-stored template information and the point grid map, and output classification information for template matching verification.

The processor may further include: generating a reliability of tracking trace information for verification of each of the tracking channels based on whether the tracking trace information of each of the tracking channels exists in a driving road of a host vehicle; generating a reliability of the classification information for verification of each of the tracking channels based on an accumulated reliability of the classification information of the target object of each of the tracking channels and a reliability of the classification information based on matching of the point grid map of each of the tracking channels and the pre-stored template information for each moving object; and determining the reliability of the verification information based on at least one of a number of updates of the tracking trace information of each of the tracking channels, the reliability of the tracking trace information for verification, or the reliability of the classification information for verification.

The verification protocol may include at least one: a first verification of appropriateness of a memory track of the first tracking channel to maintain a track of the first tracking channel without outputting the track of the first tracking channel; a second verification of appropriateness of an output including at least one of appropriateness of a determination that a target object of the first tracking channel is a moving object or a stationary object or appropriateness of output information of the first tracking channel; or a third verification of tracking issue performance of the first tracking channel.

The third verification of the tracking issue performance of the first tracking channel may include at least one of a verification as to whether the track of the target object of the first tracking channel is a track of an object including exhaust gas; verification as to whether the track of the target object of the first tracking channel is an occlusion track; verification as to whether the track of the target object of the first tracking channel is a track representing a pedestrian; verification as to whether the track of the target object of the first tracking channel is a track representing a one-ton truck, or a verification as to whether the track of the target object of the first tracking channel is a track of a sensor boundary region.

The processor is configured to perform output verification of at least one tracking function of the first tracking channel when reliability of the verification information is a highest level among predetermined levels, and may further include checking object tracking information of the corresponding tracking channel of the tracking channels based on verification information of the corresponding tracking channel when the reliability of the verification information is lower than the highest level.

A method and a system for verifying tracking information according to an exemplary embodiment of the present disclosure may verify output information of a system for tracking the target object of the vehicle, improving accuracy of tracking of the target object and accordingly, stability of driving control of the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of a vehicle according to an exemplary embodiment of the present disclosure.

FIG. 2 is a flowchart of an operation of a system for verifying tracking information according to an exemplary embodiment of the present disclosure.

FIG. 3 is a flowchart of an operation of updating verification information for each tracking channel in a system for verifying tracking information according to an exemplary embodiment of the present disclosure.

FIG. 4 is a flowchart of an operation of updating tracking verification information in a system for verifying tracking information according to an exemplary embodiment of the present disclosure.

FIG. 5 is a drawing for describing a moving window technique according to an exemplary embodiment of the present disclosure.

FIG. 6 is a flowchart of an operation of generating classification information for template matching verification in a system for verifying tracking information according to an exemplary embodiment of the present disclosure.

FIG. 7 is a flowchart of an operation of generating reliability of verification information in a system for verifying tracking information according to an exemplary embodiment of the present disclosure.

FIG. 8 is a drawing for describing a verification protocol according to an exemplary embodiment of the present disclosure.

FIG. 9 is a drawing for describing a verification post-processing operation of the system for verifying tracking information according to an exemplary embodiment of the present disclosure.

FIG. 10A, FIG. 10B, FIG. 10C, FIG. 10D, FIG. TOE, FIG. 11A, FIG. 11B, FIG. 11C, FIG. 12, FIG. 13A, FIG. 13B, FIG. 14A and FIG. 14B are drawings for explaining an effect of various exemplary embodiments of the present disclosure that solves the problems of the related art.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The present specification does not describe all elements of the embodiments, and general contents in the field of the present disclosure to which an exemplary embodiment of the present disclosure pertains or overlaps contents between the exemplary embodiments are omitted. The term “unit”, “module”, or “device” used in the specification may be implemented by software or hardware, and according to various exemplary embodiments of the present disclosure, a plurality of “units”, “modules”, or “devices” may be implemented as one element, or one “unit”, “module”, or “device” may include the plurality of elements.

Throughout the specification, when a portion is “connected” to another portion, this includes not only a case of being directly connected but also a case of being indirectly connected, and the indirect connection includes being connected through a wireless communication network.

Furthermore, when a portion “includes” an element, this means that other elements may be further included, rather than excluding other elements, unless specifically stated otherwise.

Terms including ordinals such as “first”, “second”, etc. may be used to describe various elements, but the elements are not limited by the terms. The terms are used only for distinguishing one component from another component.

A singular expression includes a plural expression unless the context clearly indicates otherwise.

In each step, the identification symbol is used for convenience of description, and the identification symbol does not describe the order of each step, and each step may be performed differently from the stated order unless a specific order is clearly described in the context.

Hereinafter, operation principles and embodiments of the present disclosure will be described with reference to the accompanying drawings.

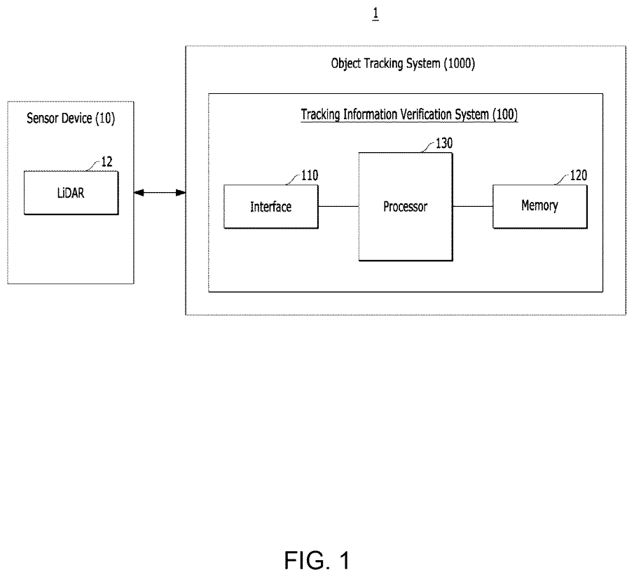

FIG. 1 is a block diagram of a vehicle according to an exemplary embodiment of the present disclosure.

Referring to FIG. 1, a vehicle 1 may include a sensor device 10 and/or an object tracking system 1000.

The sensing device 10 may include one or more devices configured for obtaining information related to an object (also referred to as a target object) located around the vehicle 1.

The sensing device 10 may include a Light Detection and Ranging (LiDAR) 12.

The LiDAR 12 may be one or a plurality, and may be mounted in the vehicle 1 to generate LiDAR data, that is, a plurality of point data (also referred to as LiDAR points) by emitting a laser pulse toward the periphery of the vehicle 1.

Meanwhile, although not shown, the sensor device 10 may further include a radio detection and ranging (RADAR) configured for detecting an object around the vehicle 1 and/or a camera configured for obtaining image data around the vehicle 1.

The object tracking system 1000 may include a tracking information verification system 100.

The tracking information verification system 100 may include an interface 110, a memory 120, and/or a processor 130.

The interface 110 may transmit a command or data input from another device (e.g., the sensing device 10 and/or a vehicle control device) of the vehicle 1 or a user to another feature element of the tracking information verification system 100, or may output a command or data received from another feature element of the tracking information verification system 100 to another device of the vehicle 1.

The interface 110 may include a communication module to communicate with other devices of the vehicle 1.

For example, the communication module may include a communication module configured for performing communication between devices of the vehicle 1, for example, Controller Area Network (CAN) communication and/or Local Interconnect Network (LIN) communication, through a vehicle communication network. Furthermore, the communication module may include a wired communication module (i.e., a power line communication module) and/or a wireless communication module (i.e., a cellular communication module, a Wi-Fi communication module, a short-range wireless communication module, and/or It may include a global navigation satellite system (GNSS) communication module.

The memory 120 may store various data used by at least one feature element of the tracking information verification system 100, i.e., input data and/or output data for a software program and commands associated therewith.

The memory 120 may include a nonvolatile memory such as a cache, a Read Only Memory (ROM), a Programmable ROM (PROM), an Erasable Programmable ROM (EPROM), an Electrically Erasable Programmable ROM (EEPROM), and/or a flash memory, and/or a volatile memory such as a Random Access Memory (RAM).

The processor 130 (also referred to as a control circuit or a controller) may be configured for controlling at least one other feature element (i.e., a hardware feature element (i.e., the interface 110 and/or the memory 120) and/or a software feature element (a software program)) of the tracking information verification system 100 and may perform various data processing and operations.

The processor 130 may update verification information of each of the tracking channels stored in the memory 120 based on output information corresponding to object tracking information of each of the tracking channels.

The processor 130 may update verification information of a corresponding tracking channel based on whether a target object of each of the tracking channels is a stationary object or a moving object.

For example, when the target object of the tracking channel is a stationary object, updating of the tracking verification information for the tracking channel is performed to update the verification information of the tracking channel.

Furthermore, when the target object of the tracking channel is a moving object, updating the verification information of the tracking channel is performed by performing updating the tracking verification information for the tracking channel and generating classification information for template matching verification.

For example, the update of the tracking verification information may include an update of tracking trace information, an update of tracking verification information, an update of classification information for verification, and/or an update of a tracking box for verification.

The generating of the classification information for the template matching verification may include generating a point grid map based on LiDAR points of a target object of a corresponding tracking channel, and determining classification information of the target object of the corresponding tracking channel based on a matching result between pre-stored template information and the point grid map.

The processor 130 may be configured to generate a reliability of verification information of each of the tracking channels.

For example, for the reliability of verification information of each of the tracking channels, the processor 130 may perform generating a reliability of tracking trace information for verification of each of the tracking channels, and generating a reliability of classification information for verification of each of the tracking channels. Furthermore, the processor 130 may be configured to generate the reliability of the verification information of each of the tracking channels based on the number of updates of the tracking trace information of each of the tracking channels, the reliability of the tracking trace information for verification, and/or the reliability of the classification information for verification.

For example, the number of updates of the tracking trace information of each of the channels may correspond to the number of updates of the tracking trace storage buffer storing the tracking trace information of each of the channels.

The processor 130 may be configured to generate a verification protocol for output verification of at least one tracking function of the first tracking channel among the tracking channels based on the reliability of the verification information, and may perform output verification of at least one tracking function of the first tracking channel.

For example, when the reliability of the verification information is a highest level (i.e., level 3) among predetermined levels, the processor 130 may perform output verification of at least one tracking function of the first tracking channel through the verification protocol.

Furthermore, when the reliability of the verification information is the level (i.e., a level 2) lower than the predetermined highest level, the processor 130 may check object tracking information of a corresponding tracking channel based on the verification information of the corresponding tracking channel among the tracking channels.

Furthermore, when the reliability of the verification information is the level (i.e., a level 1) lower than the level which is lower than the predetermined highest level, the processor 130 may not perform a check for the corresponding tracking channel.

For example, the verification protocol may include the first verification of appropriateness of a memory track of a first tracking channel to keep the track of the first tracking channel without outputting the track of the first tracking channel, a second verification of appropriateness including at least one of appropriateness of determining that a target object of the first tracking channel is a moving object or a stationary object or appropriateness of output information of the first tracking channel, and/or a third verification of a tracking issue performance of the first tracking channel.

Furthermore, the third verification of the tracking issue performance of the first tracking channel may include verification as to whether the track of the target object of the first tracking channel is a track of an object including (i.e., emitting) exhaust gas, verification as to whether the track of the target object of the first tracking channel is an occlusion track, verification as to whether the track of the target object of the first tracking channel is a track representing a pedestrian, verification as to whether the track of the target object of the first tracking channel is a track representing a one-ton truck, and/or verification as to whether the track of the target object of the first tracking channel is a track of a sensor boundary region.

The processor 130 may determine a tracking channel among the tracking channels as an abnormal tracking channel based on the output verification of at least one tracking function of the tracking channel, and perform post-processing on the abnormal tracking channel.

For example, the post-processing may include adjusting a reliability of the abnormal tracking channel, switching to a memory track of the abnormal tracking channel to maintain a track of the abnormal tracking channel without outputting the track of the abnormal tracking channel, and/or deleting the abnormal tracking channel.

Meanwhile, although the object tracking system 1000 includes the tracking information verification system 100 in the exemplary embodiment of FIG. 1, the object tracking system 1000 and the tracking information verification system 100 may be implemented as separate components according to another exemplary embodiment of the present disclosure.

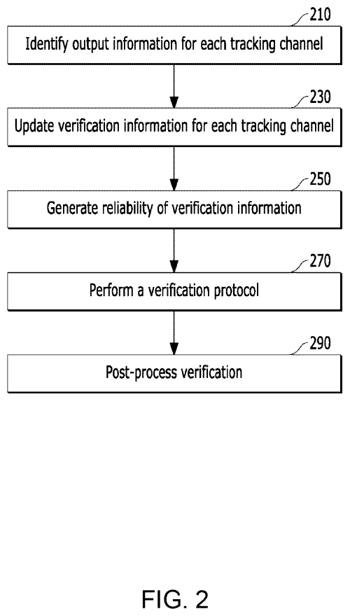

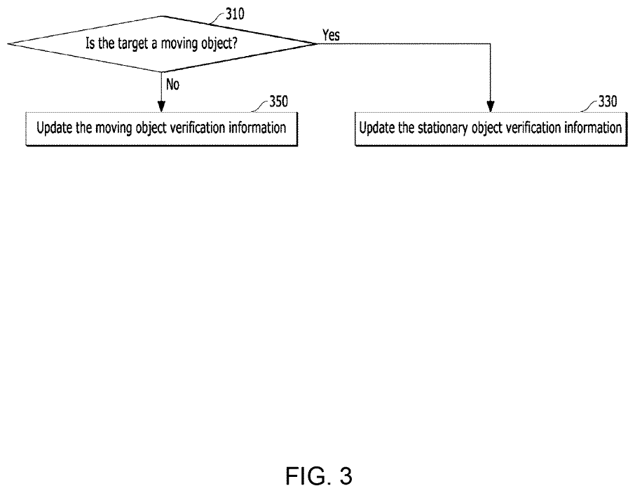

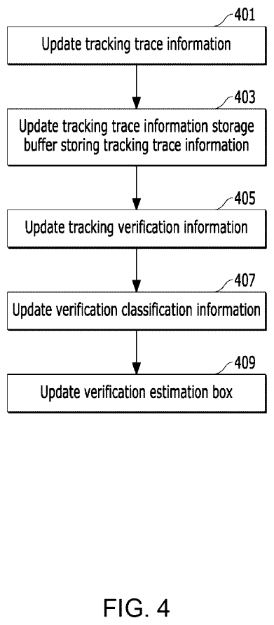

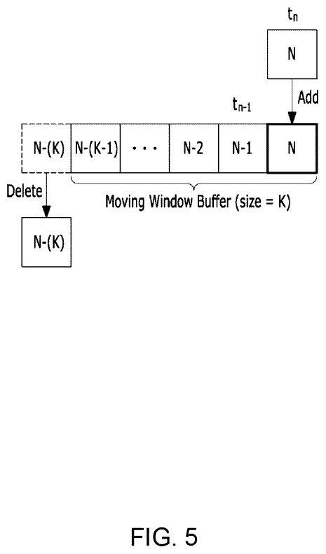

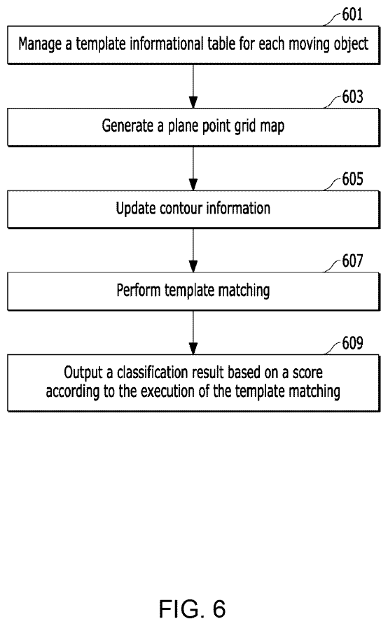

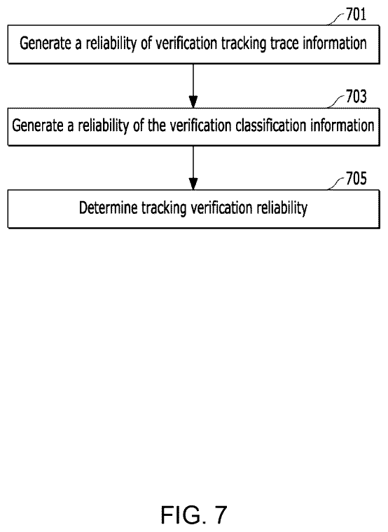

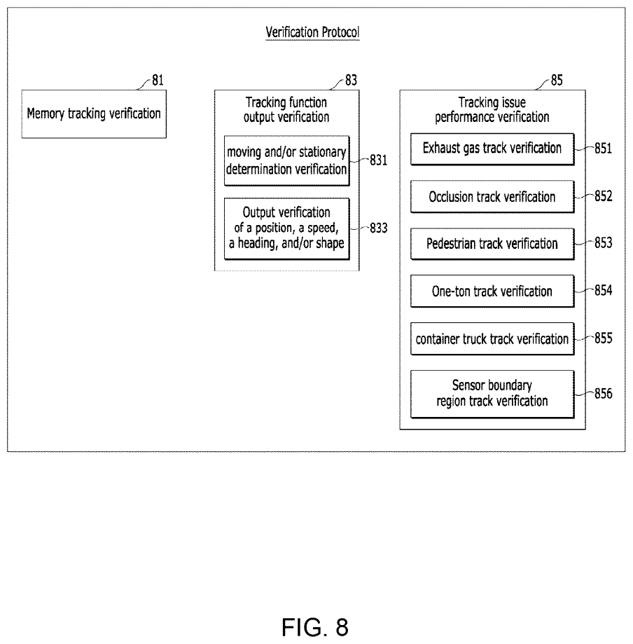

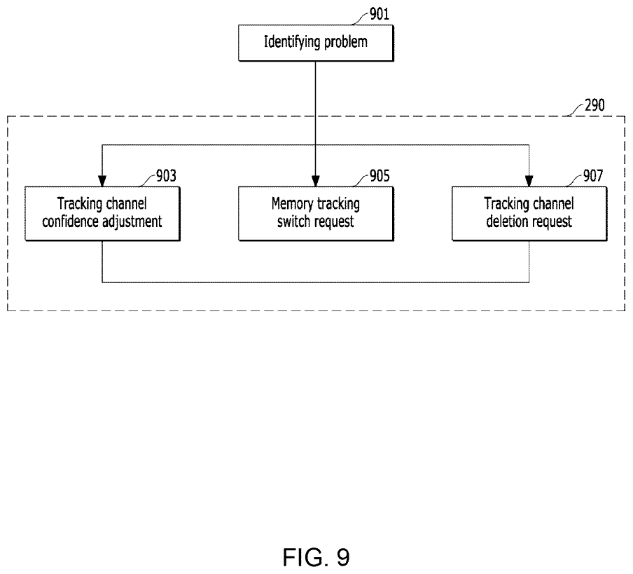

FIG. 2 is a flowchart of an operation of the tracking information verification system 100 (and/or the processor 130) according to an exemplary embodiment of the present disclosure. FIG. 3 is a flowchart of an update operation of verification information for each tracking channel of the tracking information verification system 100 (and/or the processor 130) according to an exemplary embodiment of the present disclosure. FIG. 4 is a flowchart of an operation of updating tracking verification information of the tracking information verification system 100 (and/or the processor 130) according to an exemplary embodiment of the present disclosure. FIG. 5 is a drawing for describing a moving window technique according to an exemplary embodiment of the present disclosure. FIG. 6 is a flowchart of an operation of generating classification information for template matching verification by the tracking information verification system 100 (and/or the processor 130) according to an exemplary embodiment of the present disclosure. FIG. 7 is a flowchart of a reliability generation operation of verification information of the tracking information verification system 100 (and/or the processor 130) according to an exemplary embodiment of the present disclosure. FIG. 8 is a diagram for describing a verification protocol according to an exemplary embodiment of the present disclosure. FIG. 9 is a diagram for describing a verification post-processing operation of the tracking information verification system 100 (and/or the processor 130) according to an exemplary embodiment of the present disclosure.

First, referring to FIG. 2, the tracking information verification system 100 may identify output information for each tracking channel (210).

The output information for each tracking channel may include object tracking information obtained in a process of tracking a target object based on information obtained from the sensor device 10 by the object tracking system 1000.

A tracking channel may be a space for storing object tracking information obtained from a process of tracking a target object corresponding to one ID. The number of tracking channels may be predetermined.

The tracking information verification system 100 may update verification information for each tracking channel (230).

The tracking information verification system 100 may update the verification information for each tracking channel in the same manner as in FIG. 3.

Referring to FIG. 3, the tracking information verification system 100 may be configured to determine whether the target object of output information for each tracking channel is a moving object (310).

The tracking information verification system 100 may be configured to determine whether the target object of the output information for each tracking channel is a moving object or a stationary object based on a moving or stationary determination information of each tracking channel.

The tracking information verification system 100 may perform operation 350 when the target object is not a moving object but a stationary object, and perform operation 330 when the target object is the moving object.

The tracking information verification system 100 may update stationary object verification information (330).

The update of the stationary object verification information may include an update of the tracking verification information in the manner shown in FIG. 4.

Referring to FIG. 4, the tracking information verification system 100 may update tracking trace information based on output information of a corresponding tracking channel of a target object (401).

For example, the tracking trace information may include a location, a speed, a heading, a width, a length, classification information, a tracking reliability, and/or status information of the target object.

In 403, the tracking information verification system 100 updates a tracking trace information storage buffer storing tracking trace information based on the updated tracking trace information.

The tracking information verification system 100 may update the tracking trace information storage buffer through a moving window (size=K) scheme as illustrated in FIG. 5.

Referring to FIG. 5, when tracking trace information is updated at a first time tₙ, the tracking information verification system 100 may store the updated tracking trace information N in a tracking trace information storage buffer. In the instant case, according to the designated size K of the tracking trace information storage buffer, the tracking trace information N-K stored at the earliest point in time among the tracking trace information stored in the tracking trace information storage buffer may be deleted.

The tracking information verification system 100 may update tracking verification information based on the updated tracking trace information stored in the tracking trace storage buffer (405).

The tracking verification information may include shape and/or position information for verification.

For example, the tracking verification information may include heading information of the target object included in the tracking trace information, an average width, an average length, an average speed, and/or a maximum movement distance.

The tracking information verification system 100 may store the updated tracking verification information in a tracking verification storage buffer.

The tracking information verification system 100 may update the classification information for verification (407).

The tracking information verification system 100 may be configured to determine an accumulated reliability score of the classification information of the target object based on the updated tracking verification information stored in the tracking verification storage buffer to update the determined accumulated reliability score to the classification information for verification.

The tracking information verification system 100 may be configured to determine a cumulative score of classification information based on information having a high reliability of a tracking classification. For example, the classification information (e.g., classification information may be a guardrail, a person, and/or a vehicle) of the target object of one tracking channel may be one, but there may be a plurality of pieces of classification information. Accordingly, the tracking information verification system 100 may be configured to determine the cumulative score of classification information with a high reliability for a plurality of pieces of classification information and use the cumulative score as the classification information for verification.

In 409, the tracking information verification system 100 updates the verification tracking box.

The shape of the target object may be changed according to a situation, such as a portion of the target object being covered or the entire target object being visible. Accordingly, the tracking information verification system 100 may be configured to determine the maximum width, the maximum length, and/or heading information of the target object based on the updated tracking verification information stored in the tracking verification storage buffer, and may estimate a box indicating the target object based on the determined maximum width, maximum length, and/or heading information to update the verification estimation box.

For example, the verification estimation box may estimate a shape of an occlusion, a sensor boundary region, and/or an inaccurate moving object located at a long distance, and may use the estimated shape for verification.

Referring back to FIG. 3, the tracking information verification system 100 may update the moving object verification information (330).

The updating of the moving object verification information may include generating classification information for template matching verification and/or updating tracking verification information.

For example, the generation of the classification information for template matching verification may include a method as illustrated in FIG. 6.

Referring to FIG. 6, the tracking information verification system 100 may manage a template information table for each moving object (601).

The tracking information verification system 100 may previously generate and manage template information for each moving object in a table form.

For example, the moving object may include a passenger vehicle, a 1-ton truck, a van, a sports utility vehicle (SUV), a commercial vehicle, a container truck, and/or a pedestrian classified according to a predetermined classification standard.

Furthermore, the template information for each moving object may be generated for each predetermined position of a corresponding moving object with respect to the vehicle 1.

The template information for each moving object may be generated by sampling LiDAR points in a form of a grid map with respect to a corresponding moving object.

The tracking information verification system 100 may be configured to generate a plane point grid map for the target object based on the output information of the corresponding tracking channel of the target object (603).

The tracking information verification system 100 may update contour information in the generated point grid map (605).

The tracking information verification system 100 may update the maximum position information and/or the minimum position information in the plane point grid map corresponding to the contour information of the target object. For example, the tracking information verification system 100 may update the maximum value and/or the minimum value of the rows of a column of the grid map.

The tracking information verification system 100 may perform template matching (607).

The tracking information verification system 100 may perform matching between the template information table for each moving object and the plane point grid map of the target object.

The tracking information verification system 100 may assign a score to a grid cell of the plane point grid map of the target object, which is matched with the template information table for each moving object.

The tracking information verification system 100 may output a classification result based on a score according to the execution of the template matching (609).

The tracking information verification system 100 may be configured to determine a final matching score by summing all scores of each grid cell of the grid map.

For example, the tracking information verification system 100 may be configured to determine the final matching score by summing all scores of each grid cell of the grid map to which a score is assigned according to matching with the first template information table in the template information table for each moving object.

When the final matching score exceeds a first threshold value, the tracking information verification system 100 may be configured to generate classification information indicating the moving object of the matched template information table and output the classification information as a result.

When the final matching score does not exceed the first threshold value, the tracking information verification system 100 may not output the classification information.

Meanwhile, the tracking verification information of the moving object may be updated in the manner described above with reference to FIG. 4.

Referring back to FIG. 2, the tracking information verification system 100 may be configured to generate a reliability of verification information (250).

The tracking information verification system 100 may be configured to generate a reliability of verification information in the same manner as in FIG. 7.

Referring to FIG. 7, in 701, the tracking information verification system 100 may be configured to generate a reliability of tracking trace information for verification.

The tracking information verification system 100 may identify road information, and may update the reliability of the tracking trace for verification by accumulating the reliability (also referred to as a reliability value or a reliability score) of the tracking trace for verification based on the road information.

For example, the tracking information verification system 100 may increase the reliability of the tracking trace information for verification when the tracking trace information for verification is a path existing in the driving road of the vehicle 1.

The cumulative reliability range of the tracking trace information for verification may be from 0 to 100, and a second threshold value may be 50.

The reliability of the tracking trace information for verification may be 0 (default) or 1 (reliable value).

For example, the tracking information verification system 100 may finally output the reliability of the tracking trace information for verification as 1 when the accumulated reliability of the tracking trace information for verification exceeds the second threshold value, and otherwise, may finally output the reliability of the tracking trace information for verification as 0.

The tracking information verification system 100 may be configured to generate the reliability of the classification information for verification (703).

The tracking information verification system 100 may update the reliability of the classification information for verification based on the reliability of the accumulated classification information and/or the template matching-based reliability of the classification information for verification.

For example, the reliability range of the accumulated tracking classification information may include 0 to 250, and the second threshold value may be 30 in the case of the first step and 200 in the case of the second step.

Furthermore, the range of the reliability of the template matching-based classification information for verification may be equal to or more than 0 or be equal to more or less than 200, 130 when a third threshold value is 130 in the case of step 1, and 150 in the case of step 2.

The tracking information verification system 100 may be configured to determine the reliability of the classification information for verification according to Table 1 below.

TABLE 1

| Reliability of the | |
|---|---|
| classification | |
| information | |
| for verification | Conditions |
| 0 | Default |
| 1 | 1) The reliability of accumulated |
| | tracking classification |
| | information >= step 1, or 2) |
| | the reliability of template matching- |
| | based classification information for |
| | verification >= step 1 |
| 2 | 1) Reliability of cumulative |
| | tracking classification |
| | information > = step 1, 2) |
| | reliability of template matching-based |
| | classification information for |
| | verification >= step 2, or 3) |
| | reliability of cumulative |
| | tracking classification |
| | information >= step 1 + |
| | reliability of template matching-based |
| | classification information for |
| | verification >= step 1 |

The tracking information verification system 100 may be configured to determine a tracking verification reliability (705).

The tracking information verification system 100 may be configured to determine the tracking verification reliability according to Table 2 below.

TABLE 2

| Tracking verification | |
|---|---|
| reliability (VCL; | |
| validation confidence level) | |
| level 0 < level 1 < level | |
| 2 < level 3) | Conditions |
| Level 0 | Default |
| Level 1 | In a case in which a tracking |
| | trace storage buffer is updated |
| | to a full size (or is updated as |
| | many as the maximum number |
| | of windows of the buffer or the |
| | number of times of updating the |
| | tracking trace storage buffer |
| | is equal to or greater than a |
| | predetermined number) |
| Level 2 | In addition to the conditions for |
| | level 1, a reliability of tracking trace |
| | information >= 1 or a reliability |
| | of classification information |
| | for verification >= 1 |
| Level 3 | In addition to the conditions for |
| | level 1, a reliability of tracking trace |
| | information => 1 and a reliability of |
| | classification information |
| | for verification >= 2 |

Referring back to FIG. 2, the tracking information verification system 100 may perform a verification protocol (270).

The verification protocol may include memory track verification 81, tracking function output verification 83, and/or tracking issue performance verification 85 of FIG. 8.

The memory track verification 81 may verify whether it is appropriate to perform memory tracking for maintaining a track without outputting the track of the corresponding tracking channel.

The tracking function output verification 83 may include a moving and/or stationary determination verification 831 and an output verification 833 of a position, a speed, a heading, and/or a shape corresponding to the tracking output information.

The moving and/or stationary determination verification 831 may verify whether it is appropriate to determine the target object as a moving object or a stationary object.

It may be verified whether the determination result such as the position, speed, heading, and/or shape corresponding to the tracking output information is appropriate.

The tracking issue performance verification 85 is configured to perform an exhaust gas track verification 851. It may include occlusion track verification 852, pedestrian track verification 853, 1-ton track verification 854, container truck track verification 855 and/or sensor boundary region track verification 856.

The exhaust gas track verification 851 may verify whether track information of an exhaust-gas-emitting vehicle is present, and may verify whether the track of the target object is a track of an object including exhaust gas.

The occlusion track verification 852 may verify presence or absence of occlusion track information. In other words, the occlusion track verification 852 may verify an occlusion state of a track indicating a target vehicle in front of a preceding vehicle of the host vehicle, and when the track indicating the target vehicle in front of a preceding vehicle of the host vehicle is in a state of occlusion, may decrease the output reliability of the corresponding track and output the decreased output reliability.

The pedestrian track verification 853 may verify whether the target object is a track of pedestrian classification information based on shape, size, and/or speed information of the track of the target object.

The one-ton truck track verification 854 represents verifying the track based on the shape of the track of the target object, occlusion information, and/or tracking verification classification information.

Container truck track verification 855 represents verifying the track based on the tracking verification classification information.

Sensor boundary region track verification 856 represents verifying the track based on the tracking verification classification information in the sensor boundary region.

For example, the sensor boundary region may be determined based on whether the longitudinal distance between the vehicle 1 and the target vehicle is smaller than a predetermined threshold distance (i.e., 2 m) and the occlusion information of the boundary region.

The tracking information verification system 100 may selectively perform the above-described verification protocols based on the tracking verification reliability.

For example, the tracking information verification system 100 may be configured to determine a processing procedure when a problem is found through verification based on the tracking verification reliability.

The tracking information verification system 100 may check tracking information based on high verification data when the tracking verification reliability is level 3 which is the highest level.

For example, when the tracking verification reliability is level 3, the tracking information verification system 100 may perform an information correction, a memory track conversion, and/or a tracking channel deletion request.

When the tracking verification reliability is level 2, the tracking information verification system 100 may check tracking information based on the verification data. For example, when the tracking verification reliability is level 2, the tracking information verification system 100 may transmit a phase information message for each tracking function when a problem is found.

When the tracking verification reliability is level 1, the tracking information verification system 100 may not perform the check with the verification data.

The tracking information verification system 100 may perform verification post-processing (290).

Referring to FIG. 9, the tracking information verification system 100 may perform a verification post-processing 290 when identifying 901 that there is a problem in a tracking channel and/or output information of the tracking channel according to the above-described operations.

Referring to FIG. 9, the verification post-processing 290 may include a tracking channel confidence adjustment 903, a memory track switch request 905, and/or a tracking channel deletion request 907.

Tracking channel confidence adjustment 903 indicates that, based on identifying that there is a problem with the output information of the tracking channel, the reliability value of the tracking channel is caused to output a fixed value of a pre-specified value.

For example, the range of the tracking channel reliability may be 0 or more to 100 or less, and the reliability interval of the valid tracking channel may be greater than a predetermined value (i.e., 30).

The memory track switch request 905 indicates that the number of times of maintaining the memory track is differently set according to the memory track request value. For example, the default value of the memory track maintenance count may be 1, and the maximum value may be 3.

The tracking channel deletion request 907 indicates that, when the tracking channel deletion is requested, the corresponding tracking channel is deleted before the tracking information is updated at a time after a current time.

Meanwhile, the above-described application of the verification post-processing 290 may reflect the output information at the current time.

For example, when the tracking channel deletion is requested, the output information of the current time step may not be reflected and may be deleted before being updated at the next time. This is for debugging a processing result of the current time step.

Furthermore, operations 903, 905, and 907 in the exemplary embodiment of FIG. 9 may be performed sequentially or simultaneously.

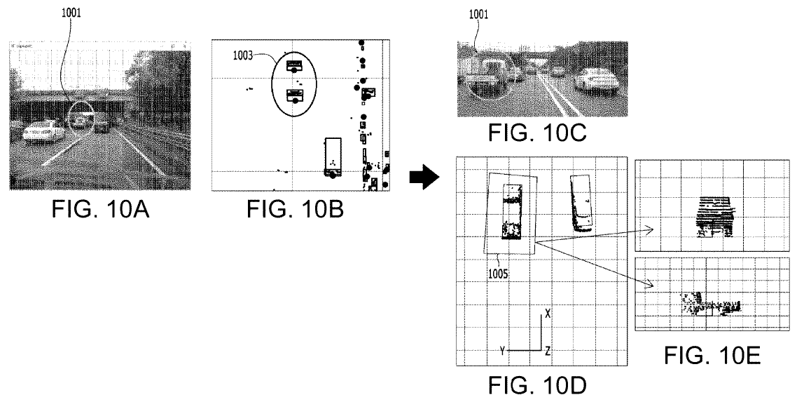

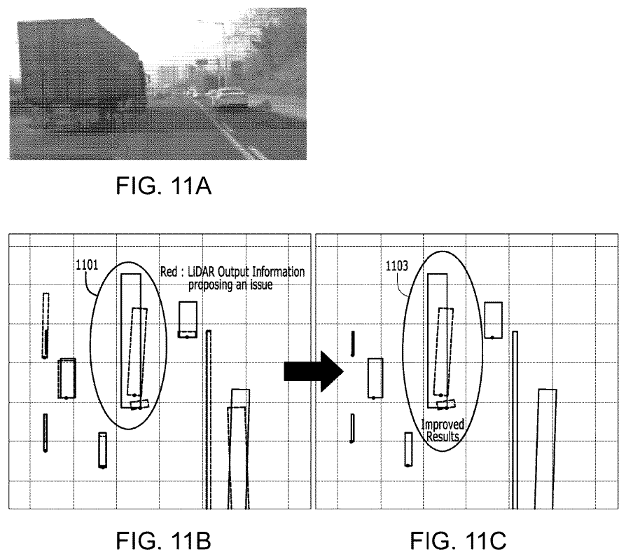

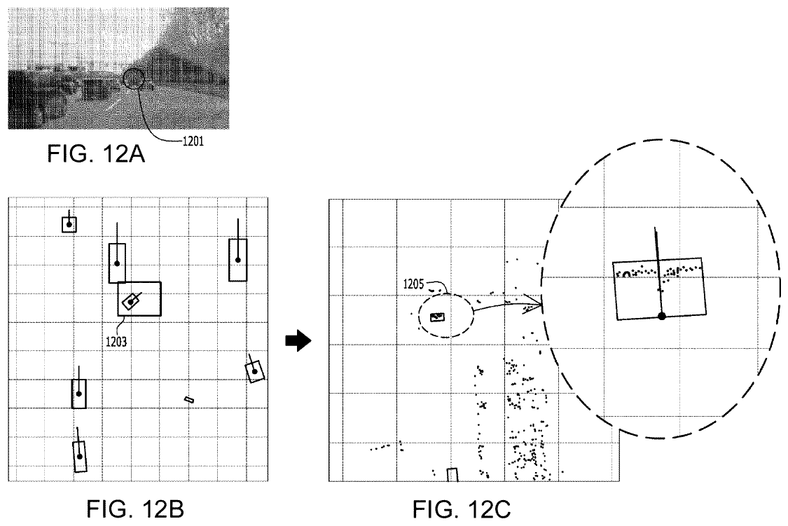

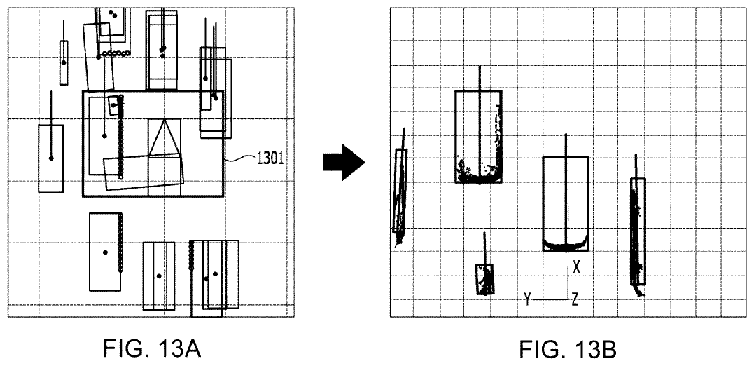

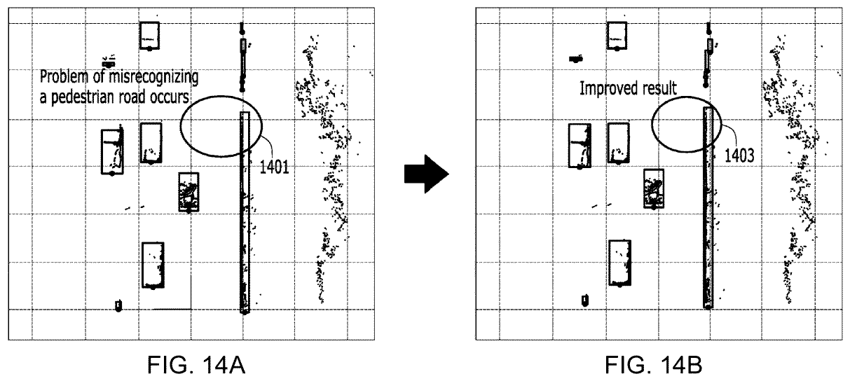

FIG. 10A, FIG. 10B, FIG. 10C, FIG. 10D and FIG. 10E, FIG. 11A, FIG. 11B and FIG. 11C, FIG. 12A, FIG. 12B and FIG. 12C, FIG. 13A and FIG. 13B and FIG. 14A and FIG. 14B are drawings for explaining an effect of various exemplary embodiments of the present disclosure that solves the problems of the related art.

As shown in FIG. 10B, two or more separated tracks 1003 are generated for a 1-ton truck 1001, which is the target object positioned at a distance equal to or greater than a predetermined distance (i.e., 30 m) from the vehicle 1 as shown in FIG. 10A, and an ID for separate tracking has been maintained for each track.

However, in the object tracking system 100 including the tracking information verification system 100 according to the above-described embodiment, when the object tracking system 100 of the vehicle 1 starts tracking if the 1-ton truck 1001 is positioned close to the vehicle 1 as illustrated in FIG. 10C, the track 1005 of the 1-ton truck 1001 as illustrated in FIG. 10D may be continuously maintained as one to solve the prior issue. FIG. 10E is a drawing illustrating an arrangement of points on the rear surface and points on the side surface of the one-ton truck 11.

Referring to FIG. 11A, FIG. 11B and FIG. 11C, in the case of a container truck as illustrated in FIG. 11A, a track separation problem 1101 indicating the container truck as illustrated in FIG. 11B may occur.

However, the object tracking system 100 including the tracking information verification system 100 according to the above-described embodiment may be configured to generate and maintain one track 1103 for the container truck as illustrated in FIG. 11C.

When the target vehicle 1201 located in front of the vehicle 1 is based on the vehicle 1, a portion of the target vehicle 1201 may be covered by another vehicle as shown in FIG. 12A, and accordingly, a heading error 1203 of an occlusion track generated with respect to the target vehicle 1201 may occur.

However, the object tracking system 100, including the tracking information verification system 100, according to the above-described embodiment, may improve the heading error 1203 of the target vehicle 1201 to generate and output a track 1205 in which the heading error is improved as shown in FIG. 12C.

A track heading error 1301 of the sensor boundary region has occurred as illustrated in FIG. 13A.

However, the object tracking system 100, including the tracking information verification system 100, according to the above-described embodiment, may improve the heading error 1203 of the target vehicle 1201 to generate and output normal tracks as shown in FIG. 13B.

In the related art as shown in FIG. 14A, a track 1401 generated for a target vehicle positioned in front of a preceding vehicle of the vehicle 1 is misrecognized as representing a pedestrian.

However, the object tracking system 100 including the tracking information verification system 100 according to the above-described embodiment may solve the prior issue by recognizing the track 1403 indicating the target vehicle positioned in front of the preceding vehicle of the vehicle 1 as a vehicle other than the pedestrian and outputting the recognition result.

The above-described embodiments may be implemented in a form of a recording medium for storing instructions executable by a computer. The instructions may be stored in a form of a program code, and when executed by a processor, may be configured to generate a program module to perform operations of the disclosed exemplary embodiments of the present disclosure. The recording medium may be implemented as a computer-readable recording medium.

The computer-readable recording medium includes all types of recording media in which computer-readable instructions are stored. For example, ROM (Read Only Examples of the optical data storage device may include a Memory, a random access memory (RAM), a magnetic tape, a magnetic disk, a flash memory, an optical data storage device, etc.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for verifying tracking information, the method comprising:
updating verification information of each of tracking channels based on output information corresponding to object tracking information of each of the tracking channels;
generating reliability of the verification information of each of the tracking channels; and
performing output verification of at least one tracking function of a first tracking channel among the tracking channels by using a verification protocol for the output verification of the at least one tracking function of the first tracking channel based on the reliability of the verification information.

2. The method for verifying tracking information of claim 1, further includes determining the first tracking channel as an abnormal tracking channel based on the output verification of the at least one tracking function and performing post-processing on the abnormal tracking channel.

3. The method for verifying tracking information of claim 2, wherein the post-processing includes at least one of adjusting reliability of the abnormal tracking channel, switching to a memory track to maintain a track of the abnormal tracking channel without outputting the track of the abnormal tracking channel, or deleting the abnormal tracking channel.

4. The method for verifying tracking information of claim 1, wherein the updating of the verification information of each of the tracking channels includes performing at least one of updating tracking verification information for each of the tracking channels or generating classification information for template matching verification based on whether a target object of each of the tracking channels is a stationary object or a moving object.

5. The method for verifying tracking information of claim 4, wherein the updating of the tracking verification information includes:
updating tracking trace information including a position, a velocity, a heading, a width, a length, a classification information, and a tracking reliability or a status information of the target object of a corresponding tracking channel based on the output information of the corresponding tracking channel;
updating tracking verification information including a heading, an average width, an average length, an average velocity, or a maximum movement distance of the target object of the corresponding tracking channel based on the updated tracking trace information;
determining an accumulated reliability score of the classification information of the target object of the corresponding tracking channel based on the updated tracking verification information to update the classification information for verification; and
updating a tracking box for verification based on the updated tracking verification information.

6. The method for verifying tracking information of claim 5, wherein the generating of the classification information for the template matching verification includes:
generating a point grid map based on Light Detection and Ranging (LiDAR) points of the target object of the corresponding tracking channel; and
determining and outputting classification information of the target object of the corresponding tracking channel based on a matching result between pre-stored template information and the point grid map.

7. The method for verifying tracking information of claim 1, wherein the generating of the reliability of the verification information includes:
generating a reliability of the tracking trace information for verification of each of the tracking channels based on whether the tracking trace information of each of the tracking channels exists in a driving road of a host vehicle;
generating a reliability of the classification information for verification of each of the tracking channels based on accumulated reliability of classification information of the target object of each of the tracking channels and a reliability of matching-based classification information of a point grid map of each of the tracking channels and pre-stored template information for each moving object; and
determining the reliability of the verification information based on at least one of a number of updates of the tracking trace information of each of the tracking channels, the reliability of the tracking trace information for verification, or the reliability of the classification information for verification.

8. The method for verifying tracking information of claim 1, wherein the verification protocol includes at least one of:
a first verification of appropriateness of a memory track of the first tracking channel for maintaining a track of the first tracking channel without outputting the track of the first tracking channel;
a second verification of appropriateness of an output including at least one of appropriateness of a determination that a target object of the first tracking channel is a moving object or a stationary object or appropriateness of output information of the first tracking channel; or
a third verification of tracking issue performance of the first tracking channel.

9. The method for verifying tracking information of claim 8, wherein the third verification of the tracking issue performance of the first tracking channel includes at least one of:
a verification as to whether the track of the target object of the first tracking channel is a track of an object including exhaust gas;
a verification as to whether the track of the target object of the first tracking channel is an occlusion track;
a verification as to whether the track of the target object of the first tracking channel is a track representing a pedestrian;
a verification as to whether the track of the target object of the first tracking channel is a track representing a one-ton truck, or
a verification as to whether the track of the target object of the first tracking channel is a track of a sensor boundary region.

10. The method for verifying tracking information of claim 1,
wherein the output verification of the at least one tracking function of the first tracking channel is performed in response that the reliability of the verification information is a highest level among predetermined levels, and
wherein the method further includes: in response that the reliability of the verification information is lower than the highest level, checking object tracking information of a corresponding tracking channel among the tracking channels based on verification information of the corresponding tracking channel.

11. A system for verifying tracking information, the system comprising:
a memory configured to store verification information of each of tracking channels; and
a processor electrically connected or communicatively connected to the memory, wherein the processor is configured to:
update the verification information of each of the tracking channels stored in the memory based on output information corresponding to object tracking information of each of the tracking channels;
generate reliability of the verification information of each of the tracking channels; and
perform output verification of at least one tracking function of a first tracking channel among the tracking channels by using a verification protocol for the output verification of the at least one tracking function of the first tracking channel based on the reliability of the verification information.

12. The system for verifying tracking information of claim 11, wherein the processor is further configured to determine the first tracking channel as an abnormal tracking channel based on the output verification of the at least one tracking function and perform post-processing on the abnormal tracking channel.

13. The system for verifying tracking information of claim 12, wherein the processor is further configured to perform at least one of:
adjusting reliability of the abnormal tracking channel;
switching to a memory track of the abnormal tracking channel for maintaining a track of the abnormal tracking channel without outputting the track of the abnormal tracking channel; or
deleting the abnormal tracking channel.

14. The system for verifying tracking information of claim 11, wherein the processor is further configured to update the verification information of each of the tracking channels by performing at least one of updating tracking verification information for each of the tracking channels or generating classification information for template matching verification based on whether a target object of each of the tracking channels is a stationary object or a moving object.

15. The system for verifying tracking information of claim 14, wherein the processor is further configured to:
update tracking trace information including a position, a velocity, a heading, a width, a length, classification information, and tracking reliability or status information of the target object of a corresponding tracking channel based on output information of the corresponding tracking channel;
update tracking verification information including a heading, an average width, an average length, an average velocity, or a maximum movement distance of the target object of the corresponding tracking channel based on the updated tracking trace information;
determine an accumulated reliability score of the classification information of the target object of the corresponding tracking channel based on the updated tracking verification information to update the classification information for verification; and
update a tracking box for verification based on the updated tracking verification information.

16. The system for verifying tracking information of claim 15, wherein the processor is further configured to generate a point grid map based on Light Detection and Ranging (LiDAR) points of the target object of the corresponding tracking channel, determine the classification information of the target object of the corresponding tracking channel based on a matching result between pre-stored template information for each moving object and the point grid map, and output classification information for template matching verification.

17. The system for verifying tracking information of claim 11, wherein the processor is further configured to:
generate a reliability of tracking trace information for verification of each of the tracking channels based on whether the tracking trace information of each of the tracking channels exists in a driving road of a vehicle;
generate a reliability of classification information for verification of each of the tracking channels based on an accumulated reliability of the classification information of a target object of the tracking channel of each of the tracking channels and a reliability of the classification information based on matching of a point grid map of each of the tracking channels and pre-stored template information for each moving object; and
determine the reliability of the verification information based on at least one of a number of updates of the tracking trace information of each of the tracking channels, the reliability of the tracking trace information for verification, or the reliability of the classification information for verification.

18. The system for verifying tracking information of claim 11, wherein the verification protocol includes at least one:
a first verification of appropriateness of a memory track of the first tracking channel to maintain a track of the first tracking channel without outputting the track of the first tracking channel;
a second verification of appropriateness of an output including at least one of appropriateness of a determination that a target object of the first tracking channel is a moving object or a stationary object or appropriateness of output information of the first tracking channel; or
a third verification of tracking issue performance of the first tracking channel.

19. The system for verifying tracking information of claim 18, wherein the third verification of the tracking issue performance of the first tracking channel includes at least one of:
a verification as to whether a track of the target object of the first tracking channel is a track of an object including exhaust gas;
a verification as to whether the track of the target object of the first tracking channel is an occlusion track;
a verification as to whether the track of the target object of the first tracking channel is a track representing a pedestrian;
a verification as to whether the track of the target object of the first tracking channel is a track representing a one-ton truck, or a verification as to whether the track of the target object of the first tracking channel is a track of a sensor boundary region.

20. The system for verifying tracking information of claim 11, wherein the processor is further configured to:
perform the output verification of the at least one tracking function of the first tracking channel when the reliability of the verification information is a level 3 among predetermined levels; and
check object tracking information of a corresponding tracking channel based on the verification information of the corresponding tracking channel of the tracking channels when the reliability of the verification information is a level 2 lower than the level 3.
